(19) United States
(12) Patent Application Publication
(10) Pub. No.: US 2024/0173758 A1
(43) Pub. Date: May 30, 2024

(54) METHOD FOR LOWERING TEMPERATURE IN THERMAL REMEDIATION OF CONTAMINATED SOIL

(71) Applicants: INSTITUTE OF SOIL SCIENCE, CAS, Jiangsu (CN); CHINA CONSTRUCTION EIGHTH ENGRG DIVISION CORP. LTD, Shanghai (CN)

(72) Inventors: Xin Song, Jiangsu (CN); Biao Tang, Jiangsu (CN); Qing Wang, Jiangsu (CN); Xing Chen, Shanghai (CN); Zhongyuan Li, Shanghai (CN)

(73) Assignees: INSTITUTE OF SOIL SCIENCE, CAS, Jiangsu (CN); CHINA CONSTRUCTION EIGHTH ENGRG DIVISION CORP. LTD, Shanghai (CN)

(21) Appl. No.: 18/520,349

(22) Filed: Nov. 27, 2023

(30) Foreign Application Priority Data
Nov. 28, 2022 (CN) 202211501188.9

(51) Int. Cl. B09C 1/06; B09C 1/02

(52) U.S. Cl. CPC B09C 1/06; B09C 1/02

(57) ABSTRACT

Provided is a method for lowering a temperature in thermal remediation of contaminated soil, which belongs to the field of soil and groundwater contamination control technologies. In the present disclosure, the method includes the following steps: injecting an entrainer into petroleum hydrocarbons (PHCs) contaminated soil to be remediated to allow soil remediation by thermal desorption; where the entrainer includes ethanol at a volume percentage of 10% to 50%.

### CROSS REFERENCE TO RELATED APPLICATION

This patent application claims the benefit and priority of Chinese Patent Application No. 202211501188.9, entitled “METHOD FOR LOWERING TEMPERATURE IN THERMAL REMEDIATION OF CONTAMINATED SOIL” filed on Nov. 28, 2022, the disclosure of which is incorporated herein by reference in its entirety.

### TECHNICAL FIELD

The present disclosure relates to the field of soil and groundwater remediation technologies, and in particular to a method for lowering temperature in thermal remediation of contaminated soil.

### BACKGROUND

Petroleum is one of the indispensable energy sources for the national economy and daily lives, as well as the most important fuel and chemical raw materials in modern society. With the rapid development of social economy, the demand for petroleum products has increased significantly. However, a large amount of petroleum hydrocarbons (PHCs) leak into the underground environment during the extraction, transportation, processing, storage, and application of petroleum products, causing serious soil contamination. The PHCs include long-chain alkanes and polycyclic aromatic hydrocarbons (PAHs), which are structurally stable and challenging to degrade, causing persistent and irreversible barm to the ecological system and posing a severe threat to human health. Therefore, it is necessary to find effective ways to remediate PHCs contaminated soil.

At present, thermal desorption technology, including in-situ and ex-situ, is widely used for remediating PHCs contaminated soil due to its effective results, short time and wide applicability. In-situ thermal desorption is the process of increasing the temperature of contaminated area by heating, and thereby changing the physical and chemical properties of the contaminants (the vapor pressure and solubility increase, while the viscosity, surface tension, Henry's constant, and soil-water partition coefficient decrease). Through this process, the concentration of contaminants in the gas or liquid phase is increased, ultimately leading to the removal of contaminants via liquid-phase or gas-phase extraction. The in-situ thermal desorption has attracted widespread attention due to its advantages of eliminating the need to excavate soil and removal contaminants in-situ, and has been implemented in a large number of engineering applications at real sites in recent years. The ex-situ thermal desorption is a process to heat the contaminated soil to above the boiling point of the target contaminant using either direct or indirect heating, where gasification and volatilization of the target contaminant are selectively promoted by controlling the system temperature and the material residence time. The outcome is that the target contaminant is separated from the soil particles and subsequently removed. Currently, thermal desorption generally requires electricity or fuel for heating, which has the disadvantage of excessive energy consumption. So, reducing energy consumption in thermal desorption remediation and simultaneously improving remediation efficiency is an urgent demand that requires immediate attention.

### SUMMARY

An objective of the present disclosure is to provide a method for lowering a temperature in thermal remediation of contaminated soil. The method could reduce the energy consumption of thermal remediation, leading to a decrease in overall remediation costs.

To achieve the above objective, the present disclosure provides the following technical solutions:

The present disclosure provides a method for lowering a temperature in thermal remediation of contaminated soil, including the following steps: injecting an entrainer into PHCs contaminated soil for remediation by thermal desorption; where the entrainer includes ethanol at a volume percentage of 10% to 50%.

In some embodiments, the entrainer is injected with sufficient quantity to at least saturate the PHCs contaminated soil.

In some embodiments, temperature of the thermal desorption is not lower than 120° C.

In some embodiments, the temperature range of the thermal desorption is from 120° ° C. to 200° C.

In some embodiments, duration of the thermal desorption is at least 6 hours.

In some embodiments, PHCs in the PHC's contaminated soil include diesel hydrocarbons.

In some embodiments, the entrainer has 10% to 40% of ethanol by volume.

In some embodiments, the entrainer has 20% of ethanol by volume.

In some embodiments, the remediation by thermal desorption is achieved via in-situ or ex-situ methods.

In some embodiments, a heating process of the soil remediation by thermal desorption is preferably electricity resistance heating (ERH) or thermal conduction heating (TCH).

The present disclosure provides a method for lowering the temperature in thermal remediation of contaminated soil, including the following steps: injecting an entrainer into PHCs contaminated soil for remediation by thermal desorption; where the entrainer includes ethanol at a volume percentage of 10% to 50%. The method is based on the azeotropic principle, and the removal temperature of PHCs, especially diesel hydrocarbons, can be significantly lowered by adding the entrainer. Since the boiling points for diesel of different constituents can range from 180° ° C. to 370° C., soil remediation by thermal desorption without the entrainer needs to reach at least 250° C. to achieve the desired removal effects. The entrainer of the present disclosure may lower the azeotropic point of the diesels to 100° ° C. to 120° ° C., which has a significant energy-saving effect, and shows a desirable removal effect.

### BRIEF DESCRIPTION OF THE DRAWINGS

FIG. 1 shows the heating time-temperature profile in Example 1;

FIG. 2 shows heating time-temperature profiles of entrainers at different concentrations;

FIG. 3 shows the thermal remediation efficiency in PHCs contaminated soil at 200° ° C. using entrainers with different concentrations; and

FIG. 4 shows the thermal remediation effect in PHCs contaminated soil at 120° ° C.′ using entrainers with different concentrations.

### DETAILED DESCRIPTION OF THE EMBODIMENTS

The present disclosure provides a method for lowering temperature in thermal remediation of contaminated soil, including the following steps: injecting an entrainer into PHCs contaminated soil for thermal remediation; and the entrainer is ethanol at a volume percentage of 10% to 50%.

In the present disclosure, PHC's in the soil include preferably diesel hydrocarbons. There is no special requirement on the type of the diesel hydrocarbon, and any diesel hydrocarbon well known in the industry can be used, specifically for example, #0 Diesel.

In the present disclosure, the entrainer is preferably obtained by mixing ethanol and water. The entrainer has preferably 10% to 40%, specifically 10%, 20%, and 40% of ethanol by volume.

In the present disclosure, there is no special requirement for an injection process of the entrainer. Specifically, an injection vehicle or a water pump can be used for the injection.

In the present disclosure, the entrainer is preferably injected in an amount sufficient to make moisture of the PHCs contaminated soil to be remediated saturated.

In the current disclosure, soil remediation by thermal desorption is accomplished by either in-situ or ex-situ thermal desorption, preferably in-situ thermal desorption. There is no special limitation on the implementation of the in-situ thermal desorption and the ex-situ thermal desorption, which can be conducted according to processes well known in the art.

In the current disclosure, soil remediation by thermal desorption is carried out for a minimum of 6 h at temperature of ideally between 120 and 200° C. There are no particular requirements for the exact heating duration, which is determined by the size of the restoration site and the concentration contaminants.

In the present disclosure, a heating process of soil remediation by thermal desorption is preferably resistance heating or conduction heating. There are no unique requirements for ERH or TCH methods, and well-known heating methods can be employed.

The method is based on an azeotropic principle, and the removal temperature of PHCs, especially diesel hydrocarbons, may be significantly lowered by adding an entrainer. Since the diesel hydrocarbons have a boiling point of 180° ° C. to 370° ° C., soil remediation by thermal desorption without the entrainer needs to reach at least 250° ° C. to achieve a removal efficiency. The entrainer of the present disclosure may lower an azeotropic point of the diesel hydrocarbons to 100° ° C. to 120° C., has a significant energy-saving effect, and shows a desirable removal effect.

The method for lowering temperature in thermal remediation of contaminated soil provided by the present disclosure is described in detail below with reference to the examples, but these examples may not be understood as a limitation to the protection scope of the present disclosure.

### Example 1

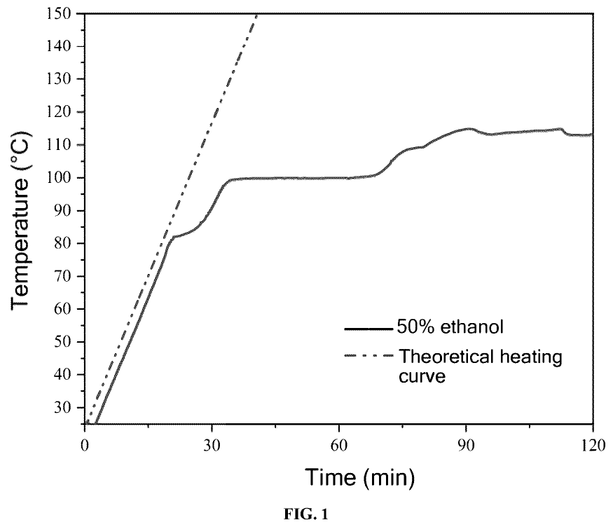

PHCs with a saturation rate of 30% (ratio of the volume of PHCs to the volume of pores) was added in a porous medium to simulate contaminated soil, 125 g of 40 mesh to 80 mesh quartz sand was added into a three-neck flask, and 10 mL of #0 Diesel and 20 mL of entrainer (with 50% of ethanol by volume, specifically including 10 mL of the ethanol and 10 ml of ultrapure water) were added. A temperature thermocouple, a condenser tube, and a glass stopper were connected to the left, middle, and right openings of the three-neck flask in sequence, tightened, and subsequent devices were connected tightly in sequence. The condensation water switch was turned on, followed by the heating power supply, to allow heating to a preset temperature of 120° ° C. Temperature changes were recorded every 2 s with a temperature detector to record the changes in temperature over time. The results are shown in FIG. 1.

As shown in the heating curve in FIG. 1, when an entrainer was added to heat the PHCs contaminated soil, the temperature in the azeotropic stage was 100° ° C. to 116° C., while the theoretical boiling point of the diesel hydrocarbons was 180° ° C. to 370° C.′. This indicated that the entrainer had the potential to improve the thermal remediation efficiency of the PHCs contaminated soil with energy-saving properties.

### Example 2

1.5 kg of non-contaminated ground soil was weighed, diesel was dissolved in 1:1 (V/V) n-hexane/acetone, and the resultant combination of diesel and n-hexane/acetone was then combined with the non-contaminated soil and agitated frequently until all of the acetone evaporated. The mixed soil was aged for 1 week and then sealed and stored for later use. The contaminated soil had a total petroleum hydrocarbon (TPH) concentration of 26,300 mg/kg.

50 g of prepared contaminated soil was added to a three-neck flask, and an entrainer with 10% of ethanol by volume was added to the contaminated soil until the soil was fully submerged. The heating device was started at a set temperature of 200° C.′, and the temperature changes were recorded every 2 seconds with a temperature detector.

### Example 3

This example differed from Example 2 only in that the entrainer had 20% of ethanol by volume.

### Example 4

This example differed from Example 2 only in that the entrainer had 40% of ethanol by volume.

### Example 5

This example differed from Example 2 only in that the heating was conducted at 120° C.

### Example 6

This example differed from Example 3 in that the heating was conducted at 120° C.

Control Group 1

This control group differed from Example 2 in that the contaminated soil with saturated moisture was directly heated at 200° ° C. without adding ethanol.

Control Group 2

This control group differed from Example 2 in that the contaminated soil with saturated moisture was directly heated at 120° ° C. without adding ethanol.

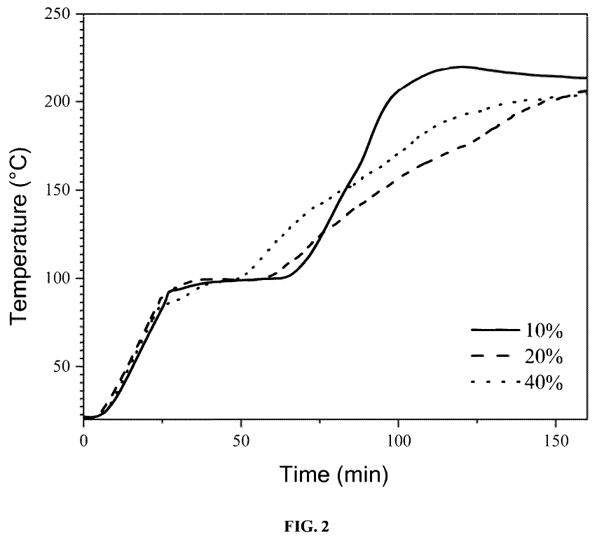

The heating time-temperature curves obtained according to Examples 2 to 4 are shown in FIG. 2. As shown in FIG. 2, when ethanol had a volume concentration of 40%, the azeotropic stage was shortest, and the azeotropic temperature was located near 100° C. The entrainer could significantly lower the temperature in the azeotropic zone of the mixture.

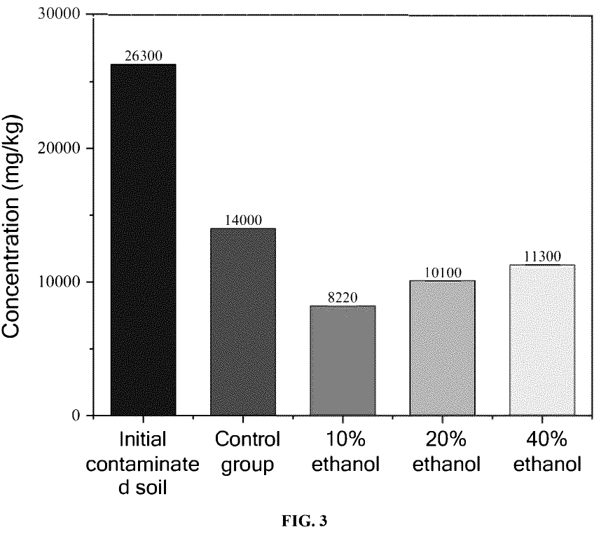

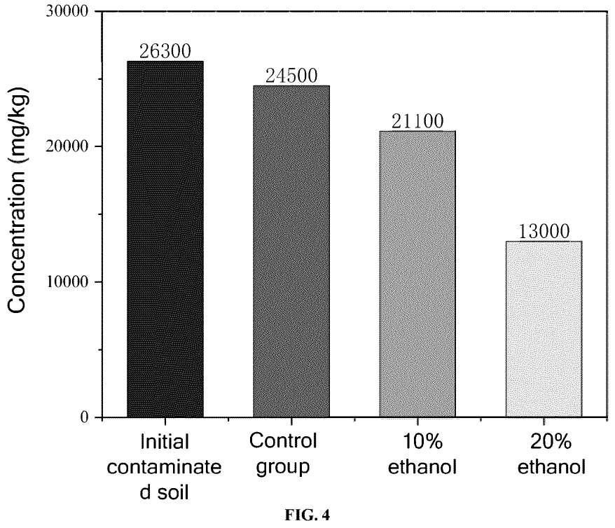

FIG. 3 shows the thermal remediation effect of PHCs contaminated soil at 200° ° C. using entrainers with different concentrations. FIG. 4 shows the thermal remediation effect of PHCs contaminated soil at 120° ° C. using entrainers with different concentrations. As shown in FIG. 3, an initial soil PHCs contaminant concentration was 26,300 mg/kg; after heating at 200° ° C., the removal amount of the entrainer added reached more than 15,000 mg/kg, which was higher than that of the control group and exceeded the concentration of general PHCs contaminated sites. The remediation and removal quantities of the entrainer applied reached more than 5,200 mg/kg, as shown in FIG. 4, under low-temperature thermal remediation at 120° C., and were both greater than those in the control group. In addition, as shown in FIG. 3 and FIG. 4, compared with adding a low-concentration ethanol entrainer, the amount of contaminants removed by adding a high-concentration ethanol entrainer was lower. The reason might be that the volatility of high-concentration ethanol caused the system to evaporate before reaching the azeotropic stage. Based on the above conclusions and the factors of actual site remediation cost, the ethanol with a concentration of 20% was the best choice as an entrainer.

It can be seen from the above examples and comparative examples that adding an entrainer in the present disclosure may not only significantly lower the azeotropic interval temperature of the PHCs in soil, but also improve the removal efficiency of contaminants. This is extremely beneficial in terms of saving energy consumption, lowering remediation costs, or enhancing remediation effects, and provides a new perspective for the remediation of high-boiling point contaminants.

The above descriptions are merely preferred embodiments of the present disclosure. It should be noted that a person of ordinary skill in the art may further make several improvements and modifications without departing from the principle of the present disclosure, but such improvements and modifications should be deemed as falling within the protection scope of the present disclosure.

What is claimed is:

1. A method for lowering a temperature in thermal remediation of contaminated soil, comprising the following steps: injecting an entrainer into petroleum hydrocarbons (PHCs) contaminated soil to be remediated to allow soil remediation by thermal desorption; wherein the entrainer comprises ethanol at a volume percentage of 10% to 50%.

2. The method according to claim 1, wherein the entrainer is injected with sufficient quantity to at least saturate the PHCs contaminated soil.

3. The method according to claim 1, wherein a temperature of the thermal desorption is not lower than 120° ° C.

4. The method according to claim 3, wherein the temperature of the thermal desorption ranges from 120° ° C. to 200° C.

5. The method according to claim 3, wherein duration of the thermal desorption is at least 6 h.

6. The method according to claim 1, wherein PHCs in the PHCs contaminated soil comprise diesel hydrocarbons.

7. The method according to claim 1, wherein the entrainer has 10% to 40% of the ethanol by volume.

8. The method according to claim 7, wherein the entrainer has 20% of the ethanol by volume.

9. The method according to claim 1, wherein the soil remediation by thermal desorption is accomplished by either in-situ or ex-situ thermal desorption.

10. The method according to claim 1, wherein a heating process of the soil remediation by thermal desorption is electricity resistance heating (ERH) or thermal conduction heating (TCH).

11. The method according to claim 3, wherein the entrainer is injected with sufficient quantity to at least saturate the PHC's contaminated soil.
